(19) United States
(12) Patent Application Publication
(10) Pub. No.: US 2025/0333865 A1
(43) Pub. Date: Oct. 30, 2025

(54) TITANIUM NANOTUBES MODIFIED WITH COBALT OXYPHOSPHIDES FOR HYDROGEN PRODUCTION AND METHODS OF PREPARATION THEREOF

(71) Applicant: King Fahd University of Petroleum and Minerals, Dhahran (SA)

(72) Inventors: Khaled Mohammed Mansour ALAQAD, Dhahran (SA); Tarek A. KANDIEL, AlKhobar (SA); Basher CHANBASHA, Dhahran (SA); Mohamad QAMAR, Dhahran (SA); Tahir Naveed JAHANGIR, Dhahran (SA)

(73) Assignee: King Fahd University of Petroleum and Minerals, Dhahran (SA)

(21) Appl. No.: 18/953,576

(22) Filed: Nov. 20, 2024

Related U.S. Application Data
(60) Provisional application No. 63/639,261, filed on Apr. 26, 2024.

(51) Int. Cl. C25B 11/091; C25B 1/04; C25B 11/052; C25B 11/063

(52) U.S. Cl. CPC C25B 11/091; C25B 1/04; C25B 11/052; C25B 11/063

(57) ABSTRACT

An electrocatalyst useful for forming hydrogen from water by the hydrogen evolution reaction. The electrocatalyst includes a titanium (Ti)-including substrate, an array of titanium dioxide (TiO₂) nanotubes (TNTs) disposed on the Ti-including substrate, and cobalt oxyphosphide (CoOP) nanostructures disposed on the surface of the TNTs. The TNTs are crystalline, as observed by powder X-ray diffraction (PXRD). The CoOP is amorphous by PXRD, and the CoOP nanostructures are substantially spherical and have a mean size of 75 to 400 nanometers (nm).

### CROSS-REFERENCE TO RELATED APPLICATIONS

The present application claims priority to U.S. Provisional Application No. 63/639,261 filed Apr. 26, 2024, which is incorporated by reference in its entirety for all purposes.

### BACKGROUND

### Technical Field

The present disclosure is directed towards an electrode including titanium nanotubes (TNTs) modified with cobalt oxyphosphides (CoOP) useful for producing hydrogen via the hydrogen evolution reaction (HER).

### Description of Related Art

The “background” description provided herein presents the context of the disclosure generally. The work of the presently named inventors, to the extent it is described in this background section, as well as aspects of the description that may not otherwise qualify as prior art at the time of filing, are neither expressly nor impliedly admitted as prior art against the present invention.

The extensive use of fossil fuels causes many destructive effects on the climate and the natural life cycles. The development of sustainable and eco-friendly energy resources becomes urgent. In this context, hydrogen gas (H₂) is being proposed as a future energy carrier owing to its clean combustion (which produces only water as the by-product) and high gravimetric energy density. However, there is a need produce large quantities of hydrogen gas for use as an energy carrier. Conventional methods suffer from different drawbacks such as low efficiency, energy requirements, toxicity of used chemicals, high cost, large installations, or generation of secondary pollutants. For example, steam-reforming of hydrocarbons is one of the conventional techniques for producing hydrogen, but steam-reforming is energy-intensive and fossil fuel-dependent.

A promising alternative is to produce hydrogen gas from water. There are a variety of sustainable and green approaches for producing H₂ from water, such as photocatalytic water splitting, photoelectrochemical cells, and water electrolysis. Among them, water electrolysis holds great potential, mainly due to the ease of its operation and scaling up.

Electrochemical water splitting technology has a wide range of industrial applications and can be used to produce hydrogen gas. A large drawback is the high overpotential required to split water into H₂ and oxygen (O₂) gases, which limits its widespread application. Thus, efficient hydrogen evolution reaction (HER) and oxygen evolution reaction (OER) electrocatalysts need to be developed to enhance the performance of electrolyzers for hydrogen production.

Presently, several studies have concluded that the HER and OER performances of transition metal oxyphosphides are driven by three catalyst features: (1) the number of active sites, (2) electrical conductivity, and (3) the catalytic efficiency of each active site. For instance, the nano-structuring of materials remarkably increases the surface area and, thereby, the electrocatalytic activity.

Electrochemical deposition can be safely used to synthesize transition metal-based phosphide electrocatalysts. For example, the electrodeposition of CoP on porous biomass carbon membrane (CoP/C) demonstrated high performance toward HER with a low overpotential of 140 mV at 10 mAcm⁻² in an alkaline solution [H. Wu, P. Liu, M. Yin, Z. Hou, L. Hu, J. Dang, Surface modification engineering on three-dimensional self-supported NiCoP to construct NiCoOx/NiCoP for highly efficient alkaline hydrogen evolution reaction, Journal of Alloys and Compounds, 835 (2020) 155364]. Liang Su and co-workers developed CoP nanosheets activated by the in-situ electrochemical process to design a Co(OH)ₓ@CoP electrocatalyst for HER. They achieved an overpotential of 100 mV at 10 mAcm⁻² in an alkaline solution [L. Su, X. Cui, T. He, L. Zeng, H. Tian, Y. Song, K. Qi, B. Y. Xia, Surface reconstruction of cobalt phosphide nanosheets by electrochemical activation for enhanced hydrogen evolution in alkaline solution, Chemical Science, 10 (2019)].

The electrodeposition method can quickly synthesize nanostructured thin films on different supports. The stability of the loaded film depends to some extent on the nature of the support material. TiO₂ nanotubes (TNTs) created by anodization are best suited for electrocatalyst loading and quick electron transport from the electrode to the active sites because of their unique 1D morphology. In addition, the electrocatalyst nanoparticles can be readily incorporated into their porous structure.

Although several materials have been developed for hydrogen production, more electrocatalysts must be fabricated and explored using effective techniques, like the electrodeposition method, for more efficient HER.

### SUMMARY

The present disclosure relates to an electrocatalyst. The electrocatalyst includes a titanium-including substrate, an array of titanium dioxide (TiO₂) nanotubes (TNTs) disposed on the titanium-including substrate, and cobalt oxyphosphide (CoOP) nanostructures disposed on a surface of the titanium dioxide nanotubes. In some embodiments, the titanium dioxide nanotubes are crystalline by powder X-ray diffraction (PXRD), the CoOP is amorphous by PXRD, and the COOP nanostructures are substantially spherical and have a mean size of 75 to 400 nanometers (nm).

In some embodiments, the titanium-including substrate is titanium metal.

In some embodiments, the titanium dioxide nanotubes are disposed substantially perpendicular to the titanium-including substrate.

In some embodiments, the CoOP nanostructures are disposed on a surface of the titanium dioxide nanotubes which is at least one selected from an inner surface of the titanium dioxide nanotubes and a surface opposite the titanium-including substrate.

In some embodiments, the CoOP nanostructures are disposed on both an inner surface of the titanium dioxide nanotubes and a surface opposite the titanium-including substrate.

In some embodiments, the titanium dioxide nanotubes have a mean diameter of 75 to 400 nm, have a mean length of 5 to 50 micrometers (μm).

In some embodiments, the titanium dioxide nanotubes have the anatase structure.

In some embodiments, the electrocatalyst has a hydrogen evolution reaction (HER) potential required to generate a current density of 10 milliamperes per centimeters square (mA/cm²) (η₁₀) in 1.0 molar (M) potassium hydroxide (KOH) of 100 to 160 millivolts (mV) relative to the reversible hydrogen electrode.

In some embodiments, the electrocatalyst has a linear Tafel plot for overpotential vs. logarithm of current density, with a slope of 62.5 to 80 millivolt/decade (mV/dec).

In some embodiments, the electrocatalyst has a charge transfer resistance of 0.1 to 7.5 ohms per centimeter square (Ω/cm²).

The present disclosure also relates to a method of making the electrocatalyst. The method includes electrochemically anodizing the titanium-including substrate in a solution including ammonium fluoride and ethylene glycol to form an anodized substrate, calcining the anodized substrate to form a bare array, and electrochemically depositing CoOP by applying a potential of −2.5 to −0.25 V vs. silver chloride electrode (Ag/AgCl) to the bare array in an aqueous solution including a cobalt ion source and a hypophosphite source to form the electrocatalyst.

In some embodiments, ammonium fluoride is present in the solution in an amount of 0.1 to 0.50 weight percentage (wt. %).

In some embodiments, the method of making the electrocatalyst further incudes pre-anodizing the Ti-including substrate in a solution including ammonium fluoride and ethylene glycol to form a pre-anodized substrate, and ultrasonically treating the pre-anodized substrate.

In some embodiments, the electrochemically anodizing is performed at 50 to 75 volts (V).

In some embodiments, the calcining is performed at 350 to 550 degrees Celsius (° C.) for 1 to 4 hours (h).

In some embodiments, the cobalt ion source is cobalt chloride, and the hypophosphite source is sodium hypophosphite.

In some embodiments, the aqueous solution including a cobalt ion source and a hypophosphite source further includes potassium chloride and citric acid.

In some embodiments, the method of electrochemically depositing CoOP is performed with a total quantity of electrical charge of 0.5 to 7.5 coulombs per centimeter square (C/cm²).

The present disclosure also relates to a method of producing hydrogen gas by a HER. The method includes contacting the electrocatalyst of claim 1 with an aqueous electrolyte solution having a pH of 10 to 14 and applying a potential of 1 to 350 mV to the electrocatalyst and a counter electrode immersed in the aqueous electrolyte solution.

In some embodiments, the aqueous electrolyte solution includes 0.25 to 2.5 M KOH.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a method flowchart for making an electrocatalyst, according to certain embodiments.

FIG. 1B is a method flowchart for producing hydrogen gas by a hydrogen evolution reaction (HER), according to certain embodiments.

FIG. 1C shows a schematic illustration for the modification of titanium dioxide (TiO₂) nanotubes (TNTs) with cobalt oxyphosphide (CoOP) spheres, according to certain embodiments.

FIG. 2A is a field emission scanning electron microscopy (FESEM) image of TNTs disposed on the Ti-including substrate (Ti/TNTs), according to certain embodiments.

FIG. 2B is a FESEM image of TNTs disposed on the Ti-including substrate and CoOP nanostructures (Ti/TNTs/CoOP), according to certain embodiments.

FIG. 2C is a FESEM image of cross-section of the Ti/TNTs/COOP, according to certain embodiments.

FIG. 2D is a SEM image of CoOP deposited on the Ti/TNTs at high magnification at 1.0 C/cm², according to certain embodiments.

FIG. 2E is a SEM image of CoOP deposited on the Ti/TNTs at high magnification at 3.0 C/cm², according to certain embodiments.

FIG. 2F is a SEM image of CoOP deposited on the Ti/TNTs at high magnification at 5.0 C/cm², according to certain embodiments.

FIG. 2G is a SEM image of CoOP deposited on the Ti/TNTs at low magnification at 5.0 C/cm², according to certain embodiments.

FIG. 2H is an energy-dispersive X-ray (EDX) spectrum of the Ti/TNTs/COOP electrocatalyst, according to certain embodiments.

FIG. 3A is a low-resolution X-ray photoelectron spectroscopic (XPS) graph of the Ti/TNTs/COOP electrocatalyst, according to certain embodiments.

FIG. 3B is a low-resolution XPS spectrum of the Ti/TNTs/COOP electrocatalyst, according to certain embodiments.

FIG. 3C is a XPS spectra of Ti 2p core-level in the Ti/TNTs and Ti/TNTs/COOP electrocatalyst, according to certain embodiments.

FIG. 4A shows X-ray diffraction (XRD) patterns of samples of Ti foil, Ti/TNTs, and Ti/TNTs/COOP electrocatalyst, according to certain embodiments.

FIG. 4B shows Raman spectra of Ti/TNTs and Ti/TNTs/COOP electrocatalysts, according to certain embodiments.

FIG. 5A shows linear sweep voltammetry curves (LSVs) of Ti/TNTs, GC/Pt/C, Ti/TNTs/Pt/C, Ti/TNTs/COOP, Ti/COOP, CoOP deposited on fluorine-doped tin oxide (FTO/CoOP), and CoOP deposited on graphitic carbon (GC/CoP) electrodes, in 1 M potassium hydroxide (KOH) electrolyte at a scan rate of 5 mV s⁻¹, according to certain embodiments.

FIG. 5B shows Tafel plot estimated from the polarization curves of GC/Pt/C, Ti/TNTs/Pt/C, Ti/TNTs/COOP, Ti/COOP, FTO/COOP, and GC/CoOP electrocatalysts, according to certain embodiments.

FIG. 6A shows Nyquist plot for Ti/TNTs/COOP, Ti/COOP, FTO/COOP, and GC/COOP electrodes, according to certain embodiments.

FIG. 6B shows charge transfer resistance (R_{ct}) of Ti/TNTs/COOP, Ti/COOP, FTO/COOP, and GC/COOP electrodes, according to certain embodiments.

FIG. 6C shows Nyquist plot for the Ti/TNTs/COOP electrocatalyst prepared using different quantities of electrical charge measured in 1.0 M KOH at −130 mV vs RHE, according to certain embodiments.

FIG. 6D shows a plot for Ret values versus the quantity of electrical charge used for the electrodeposition of CoOP on TNTs, according to certain embodiments.

FIG. 6E shows LSVs of electrodes fabricated at different concentrations of phosphorus precursor, i.e., 0 molar (M) (Ti/TNTs/Co(OH)₂), 0.2 M (Ti/TNTs/CoOP), and 0.4 M (Ti/TNTs/CoOP), according to certain embodiments.

FIG. 6F shows an SEM image of the Ti/TNTs/COOP electrocatalyst prepared at a phosphorus precursor concentration of 0.4 M, according to certain embodiments.

FIG. 7A is a cyclic voltammetry (CV) curve for Ti/TNTs, according to certain embodiments.

FIG. 7B is a CV curve for Ti/CoOP electrocatalyst at different scan rates (i.e., 5-120 mVs⁻¹), according to certain embodiments.

FIG. 7C is a CV curve for FTO/CoOP electrocatalyst at different scan rates (i.e., 5-120 mVs⁻¹), according to certain embodiments.

FIG. 7D is a CV curve for GC/CoOP electrocatalyst at different scan rates (i.e., 5-120 mVs⁻¹), according to certain embodiments.

FIG. 8A shows Nyquist plot for the Ti/TNTs/COOP electrocatalysts measured in 1.0 M KOH at different applied potentials versus RHE, according to certain embodiments.

FIG. 8B shows Nyquist plot for FTO/COOP electrocatalysts measured in 1.0 M KOH at different applied potentials versus RHE, according to certain embodiments.

FIG. 8C shows Nyquist plot for GC/COOP electrocatalysts measured in 1.0 M KOH at different applied potentials versus RHE, according to certain embodiments.

FIG. 8D shows Nyquist plot for the Ti/TNTs/CoOP electrocatalysts measured in 1.0 M KOH at different applied potentials versus RHE, according to certain embodiments.

FIG. 8E shows LSV of the Ti/TNTs/COOP electrocatalyst measured before and after the long-term stability test (24 h) in 1.0 M KOH, according to certain embodiments.

FIG. 9A shows a SEM image of the Ti/TNTs/COOP electrocatalyst after the long-term stability test (24 h) in 1.0 M KOH at a current density of 10 mAcm⁻² at a high magnification, according to certain embodiments.

FIG. 9B shows a SEM image of the Ti/TNTs/COOP electrocatalyst after the long-term stability test (24 h) in 1.0 M KOH at a current density of 10 mAcm⁻² at a low magnification, according to certain embodiments.

FIG. 9C is an EDX spectrum of the Ti/TNTs/COOP electrocatalyst after the long-term stability test (24 h) in 1.0 M KOH at a current density of 10 mAcm⁻², according to certain embodiments.

FIG. 10A shows XRD pattern of Ti/TNTs/CoOP after the long-term stability test (24 h), according to certain embodiments.

FIG. 10B shows XPS spectra of Co 2p levels in Ti/TNTs/COOP electrode after the long-term stability test (24 h), according to certain embodiments.

FIG. 10C shows XPS spectra of P 2p core levels in Ti/TNTs/COOP electrode after the long-term stability test (24 h), according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a”, “an” and the like generally carry a meaning of “one or more,” unless stated otherwise.

Furthermore, the terms “approximately”, “approximate”, “about”, and similar terms generally refer to ranges that include the identified value within a margin of 20%, 10%, or preferably 5%, and any values therebetween.

The use of the terms “include”, “includes”, “including,” “have,” “has,” or “having” should be generally understood as open-ended and non-limiting unless specifically stated otherwise.

As used herein, “particle size” and “pore size” may be thought of as the lengths or longest dimensions of a particle and of a pore opening, respectively.

As used herein, the term “ultrasonication” or “sonication” refers to the process in which sound waves are used to agitate particles in a solution.

As used herein, the term “room temperature” refers to a temperature range of “25° C.±3° C. in the present disclosure.

As used herein, the term “electrode” refers to an electrical conductor used to contact a non-metallic part of a circuit, such as a semiconductor, an electrolyte, a vacuum, or air.

As used herein, “working electrode” refers to the electrode in an electrochemical cell/device/sensor on which the electrochemical reaction of interest is occurring.

As used herein, “counter-electrode”, is an electrode used in an electrochemical cell for voltametric analysis or other reactions in which an electric current is expected to flow.

As used herein, the term “current density” refers to the amount of electric current traveling per unit cross-section area.

As used herein, the term “Tafel slope” refers to the relationship between the overpotential and the logarithmic current density.

As used herein, the term “electrochemical cell” refers to a device capable of either generating electrical energy from chemical reactions or using electrical energy to cause chemical reactions.

As used herein, the term “water splitting” refers to the chemical reaction in which water is broken down into oxygen and hydrogen.

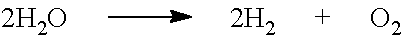

As used herein, the term “overpotential”” refers to the difference in potential that exists between a thermodynamically determined reduction potential of a half-reaction and the potential at which the redox event is experimentally observed. The term is directly associated with a cell's voltage efficacy. In an electrolytic cell, the occurrence of overpotential implies that the cell needs more energy as compared to that thermodynamically expected to drive a reaction. The quantity of overpotential is specific to each cell design and varies across cells and operational conditions, even for the same reaction. Overpotential is experimentally measured by determining the potential at which a given current density is reached.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

According to a first aspect, the present disclosure is related to an electrocatalyst. The electrocatalyst includes a Ti-including substrate, an array of titanium dioxide (TiO₂) nanotubes (TNTs) disposed on the Ti-including substrate, and CoOP nanostructures disposed on the surface of the TNTs.

In some embodiments, the Ti-including substrate may be titanium metal. Such titanium metal may be in any suitable form. Examples of suitable forms for the titanium metal include, but are not limited to, a solid titanium object, a titanium foam, and a titanium sponge. In general, the titanium metal can be unprocessed titanium, anodized titanium, nitride-coated titanium, plasma electrolytic oxidation treated titanium, oxide-free titanium, or a combination of these. It should be understood that the titanium metal can be a titanium alloy. Examples of titanium alloys include, but are not limited to Ti-5Al-2Sn-ELI, Ti-8Al-1Mo-1V, Ti-6Al-2Sn-4Zr-2Mo, Ti-5Al-5Sn-2Zr-2Mo, IMI 685, Ti 1100, Ti-6Al-4V, Ti-6Al-4V-ELI, Ti-6Al-6V-2Sn, Ti-6Al-7Nb, Ti62A, Ti-10V-2Fe-3Al, Ti-29Nb-13Ta-4.6Zr, Ti-13V-11Cr-3Al, Ti-8Mo-8V-2Fe-3Al, Beta C, and Ti-15-3. In a preferred embodiment, the Ti-including substrate is unalloyed Ti metal.

In general, the TNTs can be formed of or include titanium dioxide having any suitable crystal structure. For example, the titanium dioxide may have the anatase, rutile or brookite structure, or a combination of these. In a preferred embodiment, the TNTs have the anatase structure.

In some embodiments, the TNTs are disposed substantially perpendicular to the Ti-including substrate. As used herein, the phrase “substantially perpendicular” refers to the TNTs having a mean angle between a longitudinal axis of the TNT and the Ti-including substrate of 65 to 115°, preferably 70 to 110°, preferably 75 to 105°, preferably 80 to 100°, preferably 85 to 95°. In some embodiments, the TNTs have a relative standard deviation of an angle between a longitudinal axis of the TNT and the Ti-including substrate of less than 15%, preferably less than 12.5%, preferably less than 10%, preferably less than 7.5%, preferably less than 5%.

In some embodiments, the TNTs have a mean diameter of 75 to 400 nanometers (nm), preferably 100 to 375 nm, preferably 125 to 350 nm, preferably 150 to 325 nm, preferably 175 to 300 nm, preferably 200 to 275 nm, preferably 225 to 250 nm. In some embodiments, the TNTs of the present disclosure have a diameter which is monodisperse, having a coefficient of variation or relative standard deviation, expressed as a percentage and defined as the ratio of the diameter standard deviation (σ) to the diameter mean (μ) multiplied by 100 of less than 25%, preferably less than 10%, preferably less than 8%, preferably less than 6%, preferably less than 5%, preferably less than 4%, preferably less than 3%, preferably less than 2%. In some embodiments, the TNTs of the present disclosure have a monodisperse diameter having a diameter distribution ranging from 80% of the average diameter to 120% of the average diameter, preferably 90-110%, preferably 95-105% of the average diameter. In some embodiments, the diameter of the TNTs is not monodisperse,

In some embodiments, the TNTs have a mean length of 5 to 50 micrometers (μm), preferably 10 to 45 μm, preferably 15 to 40 μm, preferably 20 to 35 μm, preferably 25 to 30 μm. In some embodiments, the TNTs of the present disclosure have a length which is monodisperse, having a coefficient of variation or relative standard deviation, expressed as a percentage and defined as the ratio of the length standard deviation (c) to the length mean (u) multiplied by 100 of less than 25%, preferably less than 10%, preferably less than 8%, preferably less than 6%, preferably less than 5%, preferably less than 4%, preferably less than 3%, preferably less than 2%. In some embodiments, the TNTs of the present disclosure have a monodisperse length having a length distribution ranging from 80% of the average length to 120% of the average length, preferably 90-110%, preferably 95-105% of the average length. In some embodiments, the length of the TNTs is not monodisperse.

The Ti/TNTs/CoOP electrocatalyst further includes CoOP nanostructures disposed on the surface of the TNTs. In some embodiments, the CoOP nanostructures are disposed on a surface of the TNTs which is at least one selected from an inner surface of the TNTs and a surface opposite the Ti-including substrate. In a preferred embodiment, the CoOP nanostructures are disposed on both an inner surface of the TNTs and a surface opposite the Ti-including substrate.

In general, the CoOP nanostructures can be any shape known to one of ordinary skill in the art. Examples of suitable shapes the CoOP nanostructures may take include spheres, spheroids, lentoids, ovoids, solid polyhedra such as tetrahedra, cubes, octahedra, icosahedra, dodecahedra, hollow polyhedra (also known as nanocages), stellated polyhedra (both regular and irregular, also known as nanostars), triangular prisms (also known as nanotriangles), hollow spherical shells (also known as nanoshells), tubes (also known as nanotubes), nanosheets, nanoplatelets, nanodisks, rods (also known as nanorods), and mixtures thereof. In the case of nanorods, the rod shape may be defined by a ratio of a rod length to a rod width, the ratio being known as the aspect ratio. For CoOP nanostructures of the current invention, nanorods should have an aspect ratio less than 1000, preferably less than 750, preferably less than 500, preferably less than 250, preferably less than 100, preferably less than 75, preferably less than 50, preferably less than 25. Nanorods having an aspect ratio greater than 1000 are typically referred to as nanowires and are not a shape that the CoOP nanostructures are envisioned as having in any embodiments.

In some embodiments, the CoOP nanostructures have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of CoOP nanostructures having a different shape. As used herein, the term “non-uniform shape” refers to an average consistent shape that differs by more than 10% of the distribution of CoOP nanostructures having a different shape. In one embodiment, the shape is uniform and at least 90% of the CoOP nanostructures are spherical or substantially circular, and less than 10% are polygonal. In another embodiment, the shape is non-uniform and less than 90% of the CoOP nanostructures are spherical or substantially circular, and greater than 10% are polygonal. In a preferred embodiment, the CoOP nanostructures are substantially spherical in shape.

In some embodiments, the CoOP nanostructures have a mean particle size of 75 to 400 nm, preferably 100 to 375 nm, preferably 125 to 350 nm, preferably 150 to 325 nm, preferably 175 to 300 nm, preferably 200 to 275 nm, and preferably 225 to 250 nm. In embodiments where the CoOP nanostructures are spherical, the particle size may refer to a particle diameter. In embodiments where the CoOP nanostructures are polyhedral, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the CoOP nanostructures have an anisotropic shape such as nanorods, the particle size may refer to a length of the nanorod, a width of the nanorod, an average of the length and width of the nanorod. In some embodiments in which the CoOP nanostructures have non-spherical shapes, the particle size refers to the diameter of a sphere having an equivalent volume as the particle. In some embodiments in which the CoOP nanostructures have non-spherical shapes, the particle size refers to the diameter of a sphere having an equivalent diffusion coefficient as the particle.

In some embodiments, the CoOP nanostructures of the present disclosure are monodisperse, having a coefficient of variation or relative standard deviation, expressed as a percentage and defined as the ratio of the particle size standard deviation (o) to the particle size mean (u) multiplied by 100 of less than 25%, preferably less than 10%, preferably less than 8%, preferably less than 6%, preferably less than 5%, preferably less than 4%, preferably less than 3%, preferably less than 2%. In some embodiments, the CoOP nanostructures of the present disclosure are monodisperse having a particle size distribution ranging from 80% of the average particle size to 120% of the average particle size, preferably 90-110%, preferably 95-105% of the average particle size. In some embodiments, the CoOP nanostructures are not monodisperse.

In some embodiments, the materials may be crystalline or amorphous. In a preferred embodiment, the TNTs are crystalline by powder X-ray diffraction (PXRD), and the CoOP is amorphous by PXRD.

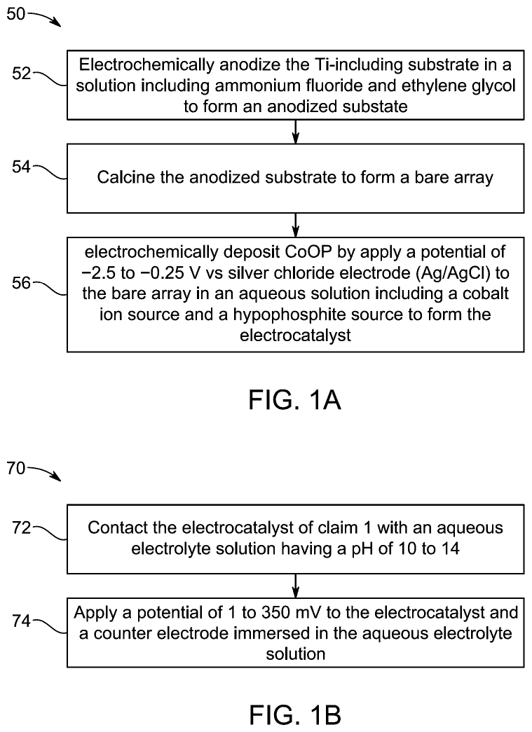

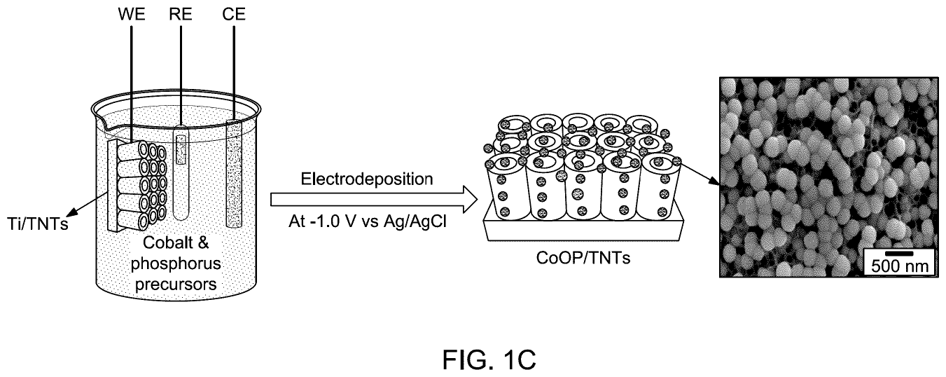

FIG. 1A illustrates a flow chart of a method 50 of making the electrocatalyst. The order in which the method 50 is described is not intended to be construed as a limitation, and any number of the described steps can be combined to implement the method 50. Additionally, individual steps may be removed or skipped from the method 50 without departing from the spirit and scope of the present disclosure.

At step 52, the method 50 includes electrochemically anodizing the Ti-including substrate in a solution including ammonium fluoride and ethylene glycol, to form an anodized substrate. In some embodiments, ammonium fluoride is present in the solution in an amount of 0.1 to 0.50 weight percentage (wt. %), preferably 0.125 to 0.45 wt. %, preferably 0.15 to 0.4 wt. %, preferably 0.175 to 0.35 wt. %, and preferably 0.2 to 0.3 wt. %. In a preferred embodiment, the concentration of ammonium fluoride in the solution is about 0.25 wt. %. In some embodiments, the electrochemical anodization is performed at 50-75 volts (V), preferably 51 to 73 V, preferably 52 to 71 V, preferably 53 to 69 V, preferably 54 to 67 V, preferably 55 to 65 V, preferably 56 to 64 V, preferably 57 to 63 V, preferably 58 to 62 V, preferably 59 to 61 V, preferably 60V.

At step 54, the method 50 includes calcining the anodized substrate to form a bare array. Typically, the calcination is carried out in a furnace preferably equipped with a temperature control system, which may provide a heating rate of up to 50 degrees Celsius per minute (° C./min), preferably up to 40° C./min, preferably up to 30° C./min, preferably up to 20° C./min, preferably up to 10° C./min, preferably up to 5° C./min. In some embodiments, the calcining is performed at 350 to 550 degrees Celsius (° C.), preferably 375 to 525° C., preferably 400 to 500° C., preferably 425 to 475° C., preferably 430 to 470° C., preferably 435 to 465° C., preferably 440 to 460° C., preferably 445 to 455° C., preferably 450° C. In some embodiments, the calcining is performed for 1 to 4 hours (h), preferably 2-3 h. In a preferred embodiment, the calcining is performed at 450° C. for 2 h at a rate of 5° C./min.

At step 56, the method 50 includes electrochemically depositing CoOP. In some embodiments, the CoOP is electrochemically deposited by applying a potential of −2.5 to −0.25 V, −2.0 to −0.5 V, preferably −1.75 to −0.60 V, preferably −1.5 to −0.75 V, preferably −1.25 to −0.9 V, preferably −1.1 to −0.95 V, preferably-1.0 V vs silver chloride electrode (Ag/AgCl) to the bare array in an aqueous solution including a cobalt ion source and a hypophosphite source to form the electrocatalyst. In some embodiments, the electrochemical deposition is performed with a total quantity of electrical charge of 0.5 to 7.5 coulombs per centimeter square (C/cm²), preferably 1 to 7 C/cm², preferably 1.5 to 6.5 C/cm², preferably 2 to 6 C/cm², preferably 2.5 to 5.5 C/cm², preferably 3 to 5 C/cm², and preferably 3.5 to 4.5 C/cm². In a preferred embodiment, the electrochemical deposition is performed with a total quantity of electrical charge of 4.0 C/cm².

In general, the cobalt ion source can be any suitable cobalt ion source known to one of ordinary skill in the art. Suitable examples of cobalt ion source include cobalt chloride, cobalt bromide, cobalt iodide, chloropentahammine cobalt chloride, hexaammine cobalt chloride, cobalt phosphate, cobalt phosphate, ammonium cobalt sulfate, diammonium tetra nitrate cobalt, cobalt acetate, cobalt formate, cobalt tetraoxide, cobalt oxalate, cobalt selenate, cobalt tungstate, cobalt molybdate, and cobalt phosphate, or hydrates or mixtures thereof. In a preferred embodiment, the cobalt ion source is cobalt chloride.

In general, the hypophosphite source can be any suitable source of the hypophosphite ion (H₂PO₂⁻) known to one of ordinary skill in the art. Suitable examples of hypophosphite sources include, but are not limited to lithium hypophosphite, sodium hypophosphite, potassium hypophosphite, calcium hypophosphite, magnesium hypophosphite, strontium hypophosphite, and mixtures of these. In some embodiments, the hypophosphite source is sodium hypophosphite.

In some embodiments, the aqueous solution, including a cobalt ion and hypophosphite sources, further includes potassium chloride. In some embodiments, the aqueous solution, including a cobalt ion and hypophosphite sources, further includes citric acid. In some embodiments, the aqueous solution, including a cobalt ion and hypophosphite sources, further includes both potassium chloride and citric acid.

In some embodiments, making the electrocatalyst further includes pre-anodizing the Ti-including substrate in a solution, including ammonium fluoride and ethylene glycol, to form a pre-anodized substrate. In some embodiments, the pre-anodizing is performed at 50 to 75 volts (V), preferably 51 to 73 V, preferably 52 to 71 V, preferably 53 to 69 V, preferably 54 to 67 V, preferably 55 to 65 V, preferably 56 to 64 V, preferably 57 to 63 V, preferably 58 to 62 V, preferably 59 to 61 V, preferably 60.

In some embodiments, the method further includes ultrasonically treating the pre-anodized substrate. In some embodiments, the ultrasonication is performed for a time range of 4 to 16 min, preferably 5 to 15 min, preferably 6 to 14 min, preferably 7 to 13 min, preferably 8 to 12 min, preferably 9 to 11 min.

FIG. 1B illustrates a flow chart of a method 70 of producing hydrogen gas by a hydrogen evolution reaction (HER). The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes contacting the Ti/TNTs/COOP electrocatalyst with an aqueous electrolyte solution having a pH of 10 to 14, preferably 10.5 to 13.9, preferably 11 to 13.8, preferably 11.5 to 13.75, preferably 12 to 13.7, preferably 13.0 to 13.65, preferably 13.60. The aqueous electrolyte solution includes water and an inorganic base. In some embodiments, the inorganic base is selected from the group consisting of an alkali metal hydroxide such as lithium hydroxide (LiOH), sodium hydroxide (NaOH), potassium hydroxide (KOH), and rubidium hydroxide (RbOH), and cesium hydroxide (CsOH). In a preferred embodiment, the base is potassium hydroxide. In some embodiments, the aqueous electrolyte solution includes 0.25 to 2.5 molar (M) KOH, preferably 0.5 to 2.0 M, preferably 0.75 to 1.5 M, preferably 0.9 to 1.25 M, preferably 1.0 M KOH.

At step 74, the method 70 includes applying a potential of 1 to 350 millivolts (mV), preferably 50 to 300 mV, preferably 100 to 250 mV, preferably 150 to 200 mV to the Ti/TNTs/COOP electrocatalyst and a counter electrode immersed in the aqueous electrolyte solution. In some embodiments, the potential is applied relative to a reference electrode. A reference electrode is an electrode that has a stable and well-known electrode potential. The high stability of the electrode potential is usually reached by employing a redox system with constant (buffered or saturated) concentrations of each relevant species of the redox reaction. A reference electrode may enable a potentiostat to deliver a stable voltage to the working electrode or the counter electrode. The reference electrode may be a standard hydrogen electrode (SHE), a normal hydrogen electrode (NHE), a reversible hydrogen electrode (RHE), a saturated calomel electrode (SCE), a copper-copper (II) sulfate electrode (CSE), Ag/AgCl, a pH-electrode, a palladium-hydrogen electrode, a dynamic hydrogen electrode (DHE), a mercury-mercurous sulfate electrode, mercury/mercuric oxide (Hg/HgO) electrode, or some other type of electrode. In a preferred embodiment, a reference electrode is Hg/HgO electrode. However, in some embodiments, the electrochemical cell does not include a third electrode.

In general, the counter electrode can be any suitable counter electrode known to one of ordinary skill in the art. In some embodiments, the counter electrode is made from a material selected from the group consisting of platinum, gold, and carbon. In some embodiments, the counter electrode may contain an electrically-conductive material such as platinum, platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10⁻⁶ Ω·m, preferably at most 10⁻⁷ Ω·m, more preferably at most 10⁻Ω·m at a temperature of 20-25° C. The form of the counter electrode may be generally relevant only in that it needs to supply sufficient current to the electrolyte solution to support the current required for the electrochemical reaction of interest. The counter electrode material should thus be sufficiently inert to withstand the chemical conditions in the electrolyte solution, such as acidic or basic pH values, without substantially degrading during the electrochemical reaction. The counter electrode should preferably not leach out any chemical substance that interferes with the electrochemical reaction or might lead to undesirable electrode contamination. In a preferred embodiment, the counter electrode is platinum.

In some embodiments, the electrocatalyst has a HER potential required to generate a current density of 10 milliamperes per centimeters square (mA/cm²) (110) in 1.0 M KOH of 100 to 160 mV, preferably 110 to 150 mV, preferably 120 to 140 mV, preferably 130 mV, relative to the RHE.

In some embodiments, the electrocatalyst has a Tafel plot for overpotential vs. logarithm of current density that is linear with a slope of 62.5 to 80 millivolt/decade (mV/dec), preferably 65.0 to 77.5 mV/dec, preferably 66 to 77 mV/dec, preferably 68 to 76 mV/dec, preferably 70.0 to 75.0 mV/dec, preferably 70.5 to 74.5 mV/dec, preferably 71.0 to 74.0 mV/dec, preferably 71.5 to 73.5 mV/dec, preferably 72.0 to 73.0 mV/dec, preferably 72.5 mV/dec. In some embodiments, the electrocatalyst has a charge transfer resistance of 0.1 to 7.5 ohms per centimeter square (Ω/cm²), preferably 1 to 7 Ω/cm², preferably 1.5 to 6.5 Ω/cm², preferably 2 to 6 Ω/cm², preferably 2.5 to 5.5 Ω/cm², preferably 3 to 5 Ω/cm², preferably 3.5 to 4.5 Ω/cm².

### EXAMPLES

The following examples demonstrate an electrode, including titanium nanotubes (TNTs) modified with cobalt oxyphosphides (CoOP), for hydrogen evolution reaction (HER). The examples are provided solely for illustration and are not to be construed as limitations of the present disclosure, as many variations thereof are possible without departing from the spirit and scope of the present disclosure.

### Example 1: Chemicals

Titania nanotube arrays were prepared using the electrochemical anodization method of titanium foil. The anodization process used a two-system electrode and variable DC voltage power supply. Typically, pieces of titanium foil are anodized for 30 minutes (min) at 60 volts (V) against a graphite rod used as a cathode. About 10 milliliters (mL) of 0.25 wt. % ammonium fluoride and ethylene glycol solution were used as electrolytes. After that, the sacrificial layer of the as-grown TiO₂ nanotube (TNTs) arrays were removed using ultrasonication in distilled water for 15 min. In the second anodization process, the first-anodized pieces of titanium foil were anodized again at 60 volts (V) for two hours (h) within the same electrolyte. Finally, the as-anodized titanium foil pieces were cleaned with an ethanolic aqueous solution (1:1) V/V to remove the impurities. Finally, the cleaned TNTs were calcined in air at 450 degrees Celsius (° C.) for 2 h with a ramping rate of 5 degrees Celsius per minute (° C./min).

### Example 2: Electrocatalyst TNTs/CoOP Preparation

The electrocatalysts were prepared by the electrodeposition process using three electrodes and an electrodeposition bath. The electrodeposition solutions with different pHs were prepared by dissolving cobalt hexahydrate and sodium hypophosphite (NaH₂PO₂) in deionized water at room temperature. Typically, 1.4 grams (g) of CoCl₂·6H₂O (Sigma Aldrich) and 1.6 g of NaH₂PO₂·H₂O (Sigma Aldrich) were dissolved in a certain volume of 0.1 M KCl aqueous solution in the presence of 1.15 g of citric acid as a chelating agent to form the electrodeposition bath. The Ti/TNTs were used as a working electrode and then immersed in the deposition bath. Platinum wire served as a counter electrode, while silver/silver chloride was the reference electrode. A negative potential of −1.0 V (vs. Ag/AgCl, 3M KCl) was applied to the Ti/TNTs electrode after a continuous purging with N₂ gas for 30 min. Different amounts of CoOP were incorporated into the TNTs by controlling the electrodeposition charges (i.e. 1.0, 2.0, 3.0, 4.0, 5.0, and 6.0 C/cm²). During the electrodeposition process, the Ti/TNTs surface was converted from gray to dark black, illustrating the successful electrodeposition of CoOP onto the TNTs surface. A schematic representation of the fabrication process of the TNTs incorporated with CoOP spheres is illustrated in FIG. 1C.

The voltammetric method was applied to measure the overpotential of prepared electrocatalysts. The demonstrated electrode's linear sweep voltammetry (LSV) voltammogram from (−1.5 to 0 vs. RHE) was tested in a solution of 1.0 M KOH at a scan rate of 5 mVs⁻¹. A Hg/HgO (1M KOH, E°=0.118 V, ALS Co.) and platinum wire were utilized as a reference and a counter electrode, respectively. Utilizing Eq. 1, the potentials obtained versus the Hg/HgO electrode were converted to the reversible hydrogen electrode (RHE) scale:

$${E}_{RHE} = {E}_{applied} + 0.0 \; 59 pH + {E}_{ref ,}^{o} ( pH ( 13.6 ) of 1. M KOH ) \qquad Eq . ( 1 )$$

The electrochemical impedance spectroscopy (EIS) measurements were performed in the frequency range from 105 to 0.01 hertz (Hz) with an AC amplitude of 10 millivolts (mV).

### Example 3: Physical Characterization

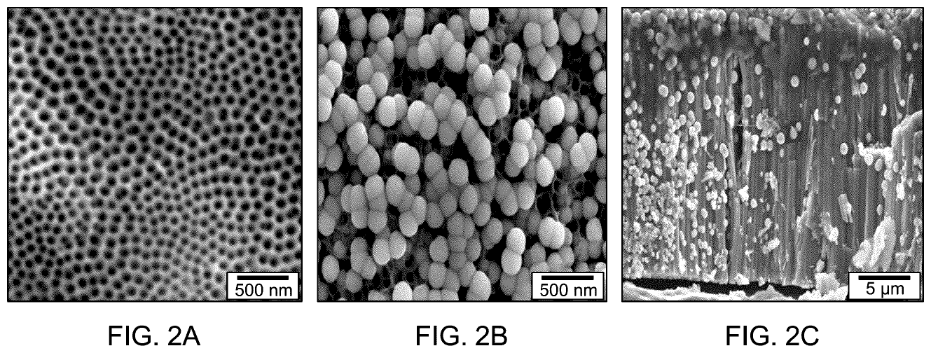

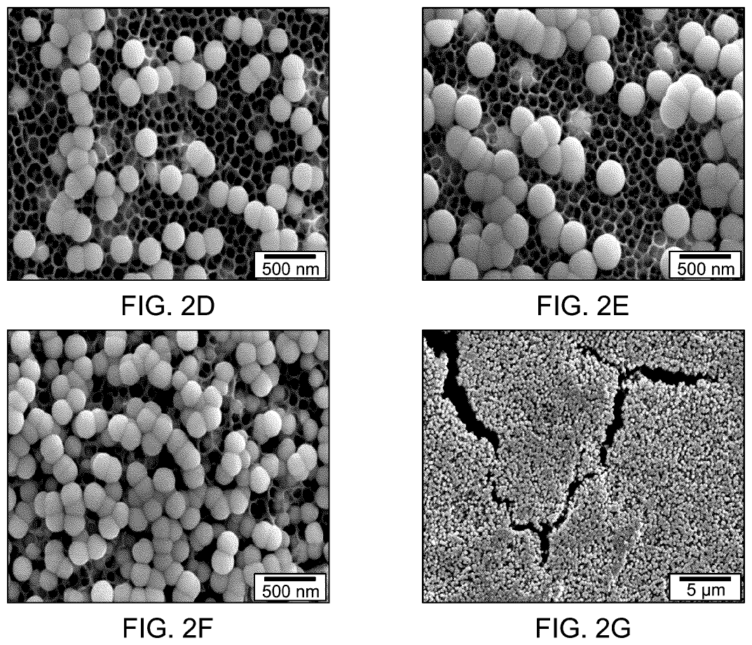

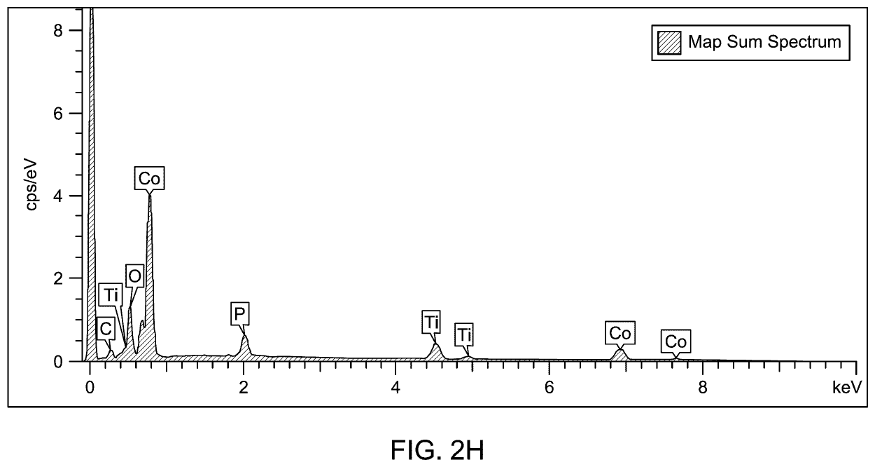

The surface morphology was observed using scanning electron microscopy (SEM). The SEM micrograph of the Ti/TNTs sample shows the formation of highly organized and interconnected TNT (FIG. 2A). At the same time, the SEM image of the electrodeposited CoOP material shows a highly spherical shape with a diameter in the range of 150 to 250 nm (FIG. 2B). It was also observed that the CoOP spheres are grown inside the TNTs as well as on the surface. The Ti/TNTs/COOP electrode was altered with many small-sized highly distributed CoOP spheres, and the TNTs were advantageous for uniform CoOP growth due to their high surface area. The cross-section micrograph (FIG. 2C) confirmed that the CoOP spheres are grown within the TNTs and are confined inside the tubes. The infiltration of CoOP spheres within the TNTs improves the electronic interaction and the physical adhesion between CoOP and TNTs substrate. FIG. 2D-FIG. 2F shows SEM images of CoOP deposited on Ti/TNTs at 1.0 C/cm², 3.0 C/cm², and 5.0 C/cm² at high magnification and FIG. 2G shows an SEM image of 5.0 C/cm² at low magnification. FIG. 2H shows an energy-dispersive X-ray (EDX) spectrum of Ti/TNTs/CoOP.

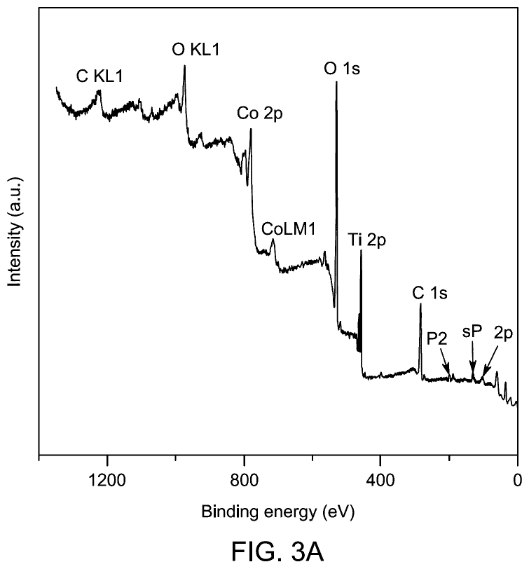

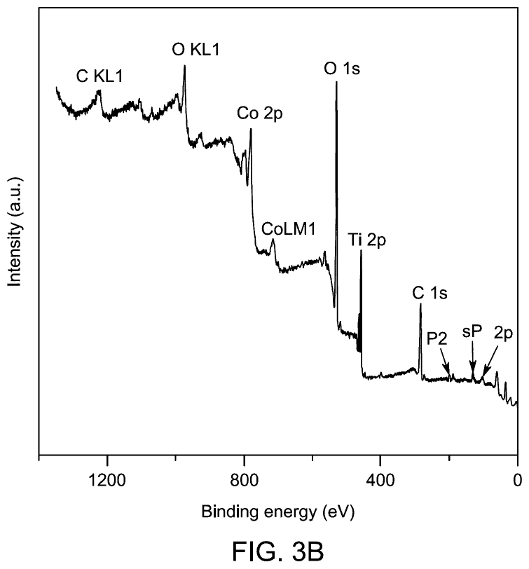

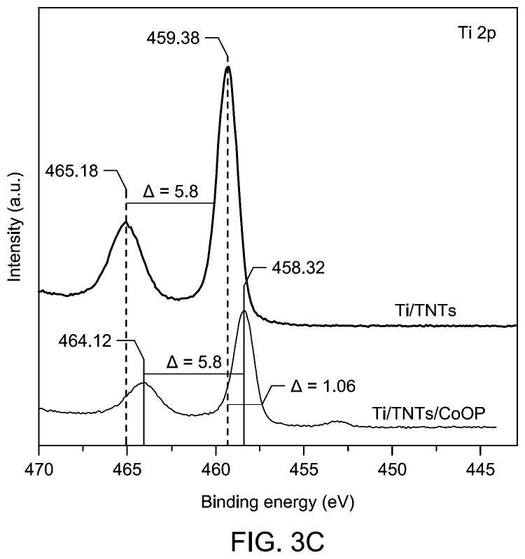

The wide scan of TNTs/COOP nanospheres surface using the X-ray photoelectron spectroscopy (XPS) is shown in FIG. 3A. It shows the presence of oxygen, carbon, and sulfur.

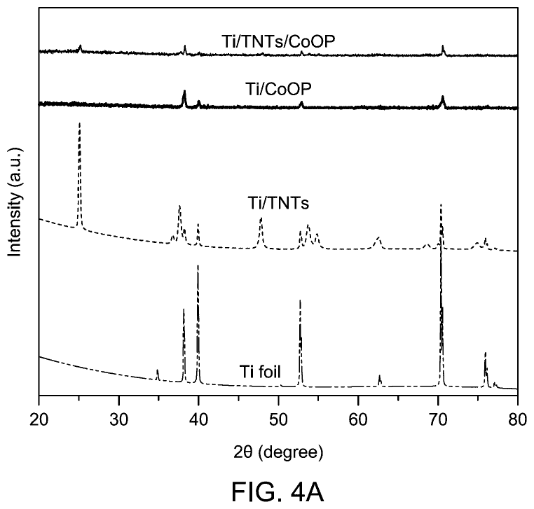

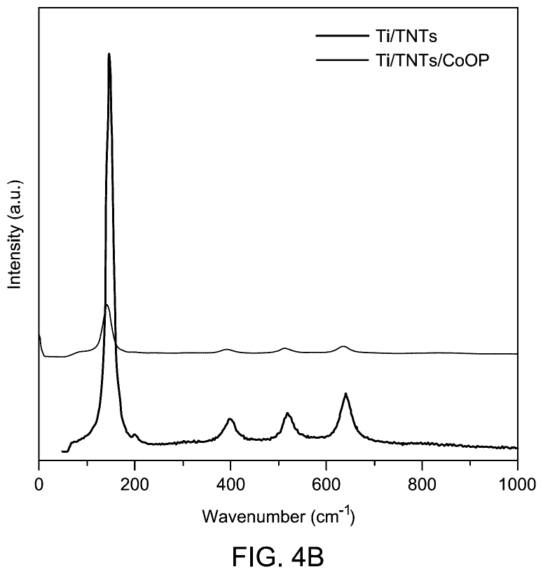

FIG. 3B shows a low-resolution XPS spectrum of Ti/TNTs/COOP electrocatalyst, while FIG. 3C shows XPS spectra of Ti 2p core-level in Ti/TNTs and Ti/TNTs/CoOP. The XRD pattern confirms the crystallinity of the TNTs with CoOP (FIG. 4A) and shows that the TNTs/CoOP electrocatalysts are amorphous. FIG. 4B shows Raman spectra of Ti/TNTs and Ti/TNTs/COOP electrocatalysts.

### Example 4. Electrochemical Characterization

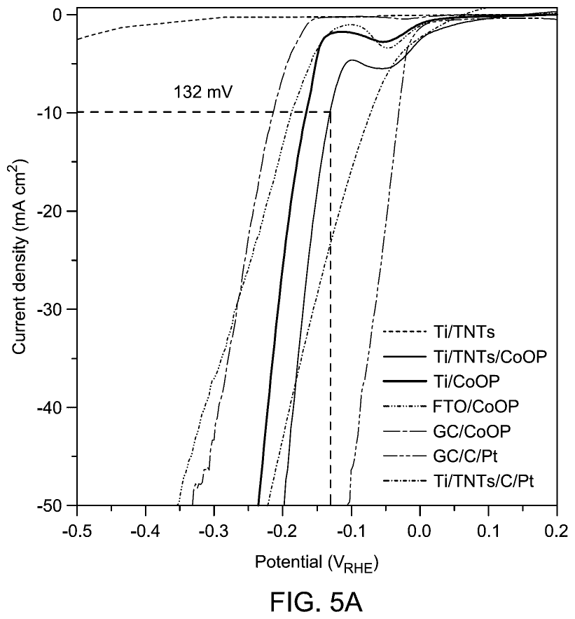

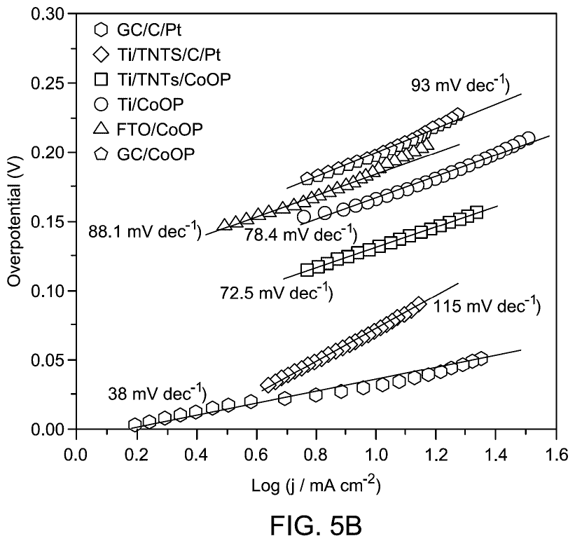

FIG. 5A shows the LSV of Ti/TNTs/COOP, Ti/COOP, FTO/COOP, and GC/COOP electrodes tested in 1 M of KOH solution. The GC/C/Pt catalyst showed an excellent HER performance and an overpotential close to approximately 33 mV at 10 mAcm⁻² in agreement with the literature. The Ti/TNTs electrode showed inferior HER activity under the same experimental conditions. The modification of Ti/TNTs with CoOP significantly improved the HER activity. The HER activity of the latter was higher than that of CoOP spheres loaded on the Ti foil, GC, and FTO substrates. A current density of 10 mAcm⁻² is obtained on GC/Pt/C, Ti/TNTs/Pt/C, Ti/TNTs/COOP, Ti/COOP, FTO/COOP, and GC/CoOP electrodes at an overpotential of 33 mV, 75 mV, 130 mV, 165 mV, 185 mV, and 214 mV, respectively. The Ti/TNTs/COOP electrode achieves higher HER activity and lower overpotential than those of Ti/TNTs and Ti/CoOP. The improved electrocatalytic activity of Ti/TNTs/COOP compared to Ti/CoOP, FTO/COOP, and GC/COOP can be attributable to the individual features of TNTs such as high surface area, good electron transfer through the 1-D direction, and the strong interaction of CoOP with the TNTs. Tafel plot estimated from the polarization curves of GC/Pt/C, Ti/TNTs/Pt/C, Ti/TNTs/COOP, Ti/COOP, FTO/COOP, and GC/CoOP electrocatalysts are shown in FIG. 5B.

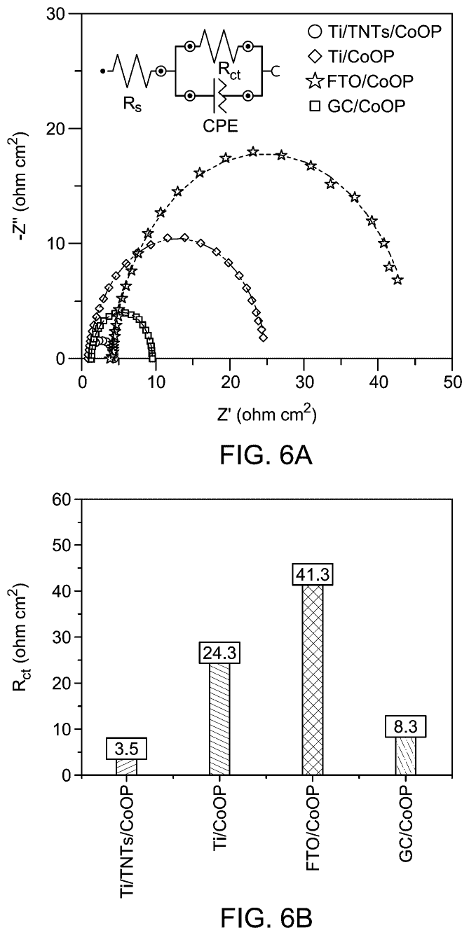

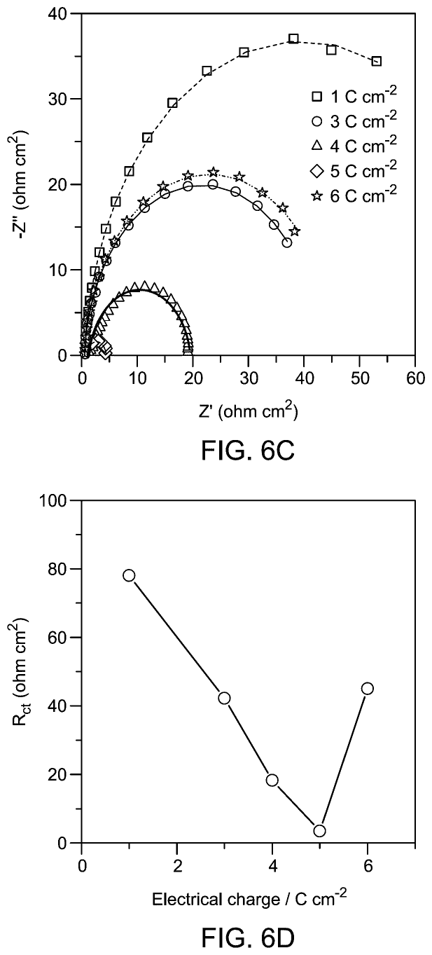

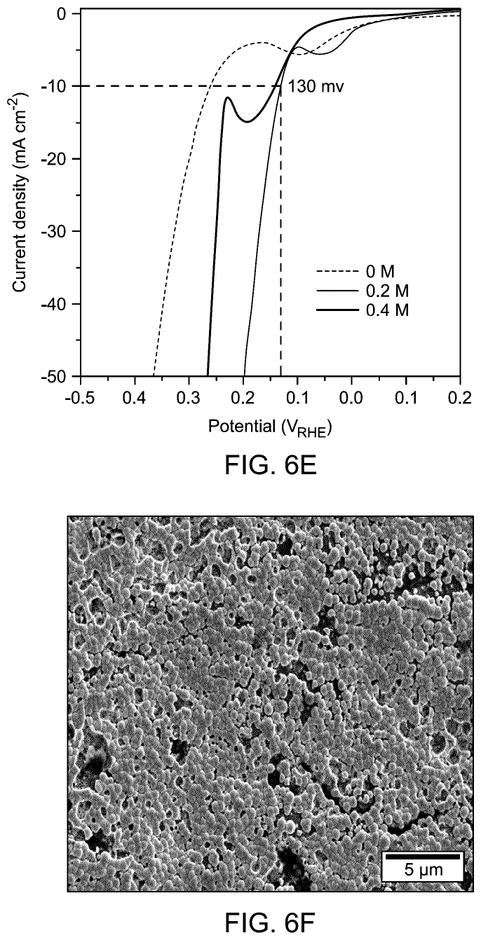

The EIS spectra of Ti/TNTs/COOP, Ti/COOP, FTO/COOP, and GC/COOP electrodes were collected at various overpotentials (i.e. from 100 to 150 mV) to estimate the charge transfer resistance at the electrocatalyst/electrolyte interface during the HER. FIG. 6A shows the Nyquist plot for the investigated electrode at −130 mV_{RHE}. It is observed that the Ti/TNTs/COOP electrode has a substantially reduced charge transfer resistance, which is attributed to the improved kinetic of charge transfer after the infiltration of TNTs with CoOP spheres. In general, the Ti/TNTs/COOP exhibits a very low charge transfer resistance compared to those of other electrodes, indicating the strong electronic interaction between TNTs and the CoOP spheres. The EIS spectra of the fabricated electrodes were fitted with an equivalent circuit (EC) consisting of a one-time constant (RC). In this EC, Rₛ refers to a collective resistance that includes wiring resistance and solvent resistance while the R_{ct} refers to the charge transfer resistance at the electrocatalyst/electrolyte interface. A constant phase element (CPE) is utilized during the fitting instead of pure capacitance to account for the surface inhomogeneities of the electrode.

FIG. 6B shows the R_{ct} values at an overpotential of −130 mV for the different electrodes. It illustrates that the R_{ct} of Ti/TNTs/COOP (3.5Ω) is much smaller than those of Ti/CoOP (24.3Ω), FTO/COOP (41.3Ω), and GC/CoOP (8.3Ω) electrodes, indicating that the kinetics of HER over CoOP incorporated into the TNTs are much faster than other substrates. This finding clearly shows that TNTs have a good interaction with CoOP in the HER. FIG. 6C shows the Nyquist plots of Ti/TNTs/COOP electrocatalysts prepared using different quantities of electrical charge measured in 1.0 M KOH at −130 mV vs RHE. FIG. 6D shows the Plot for Ret values versus the quantity of electrical charge used for the electrodeposition of CoOP on TNTs. FIG. 6E shows the LSVs of electrodes fabricated at different concentrations of phosphorus precursor, i.e. 0 M (Ti/TNTs/Co(OH)₂), 0.2 M (Ti/TNTs/CoOP), and 0.4 M (Ti/TNTs/CoOP). FIG. 6F shows the SEM image of Ti/TNTs/COOP prepared at phosphorus precursor concentration of 0.4 M.

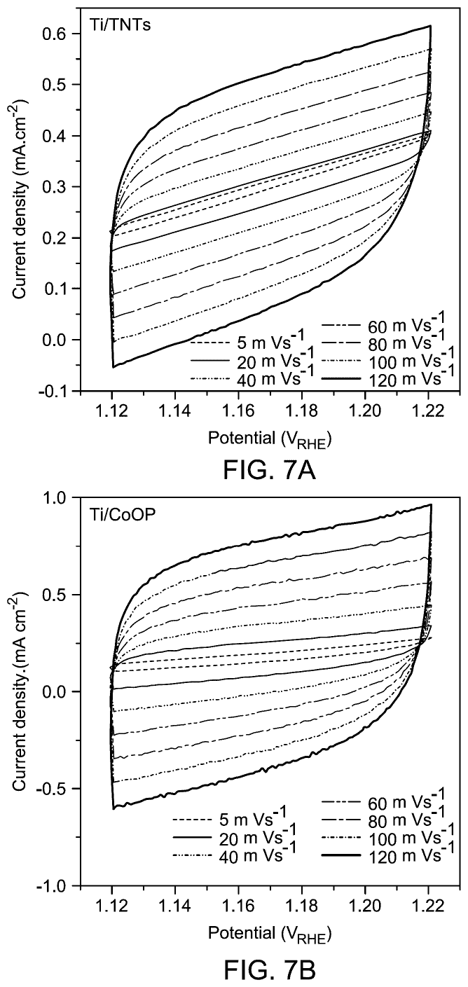

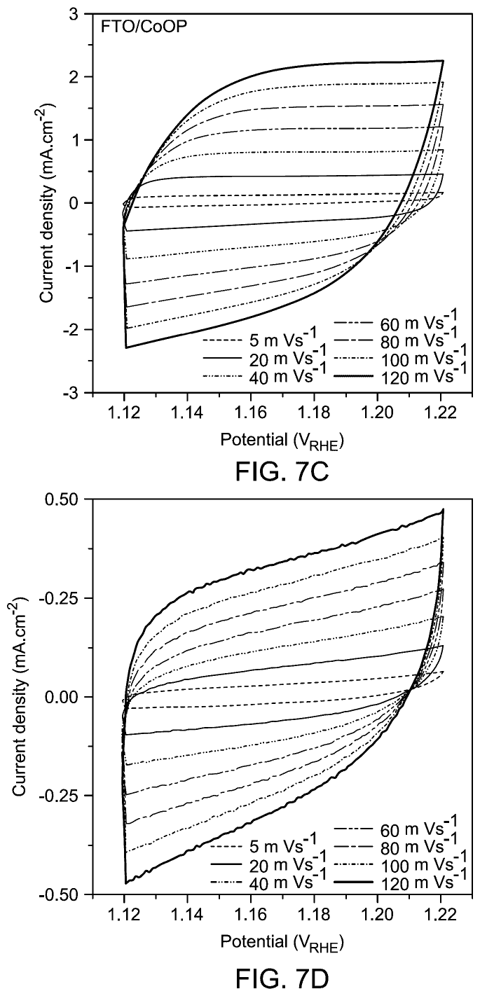

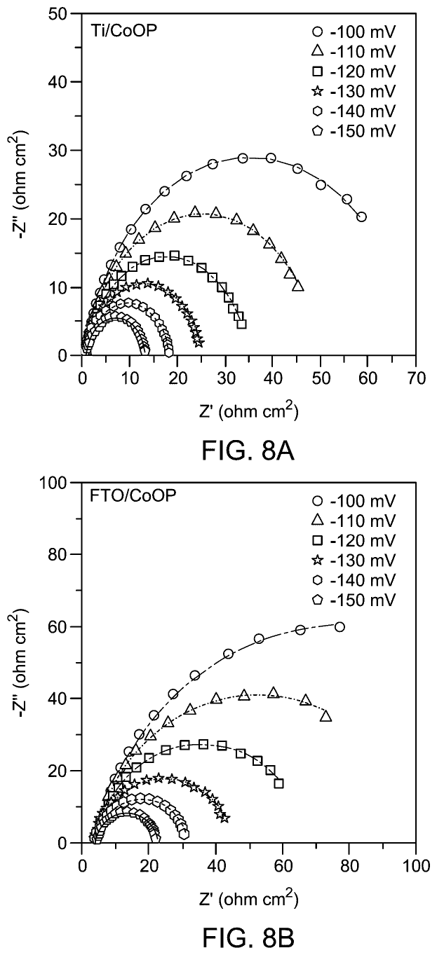

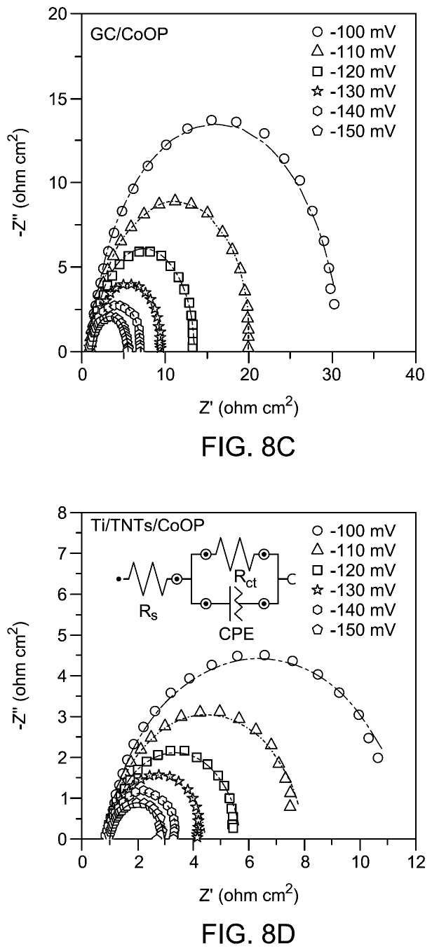

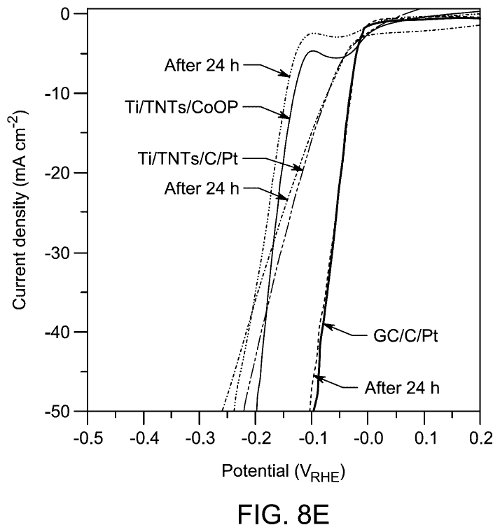

FIG. 7A-7D shows the cyclic voltammetry (CV) profiles of Ti/TNTs, Ti/COOP, FTO/COOP, and GC/COOP, respectively, at different scan rates (i.e., 5-120 mVs⁻¹). FIG. 8A-8D shows the Nyquist plots of Ti/COOP, FTO/COOP, GC/COOP, and Ti/TNTs/COOP electrocatalysts, respectively, measured in 1.0 M KOH at different applied potentials versus RHE. FIG. 8E shows the LSV of Ti/TNTs/COOP electrocatalyst measured before and after the long-term stability test (24 h) in 1.0 M KOH.

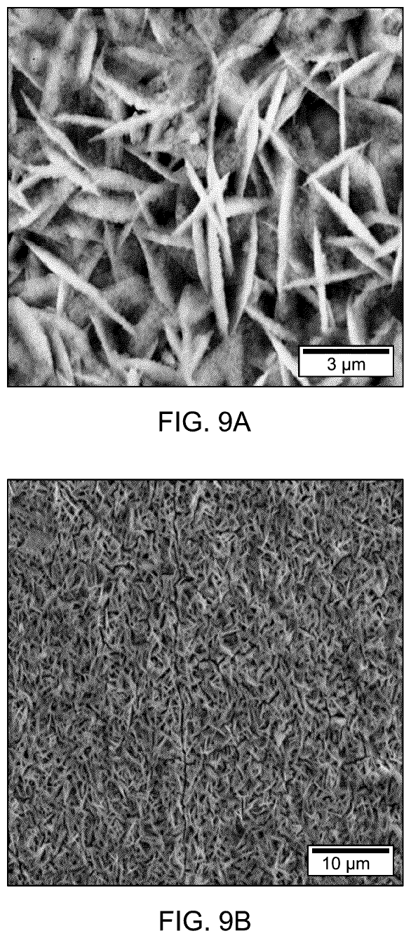

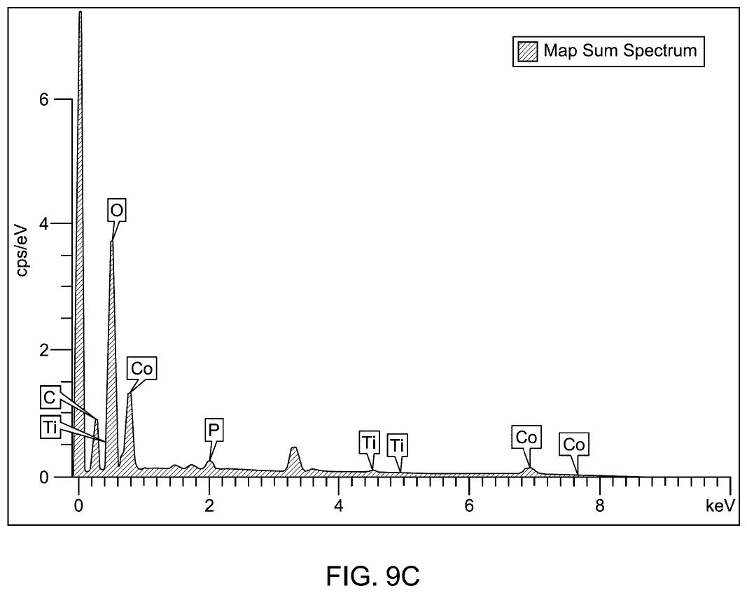

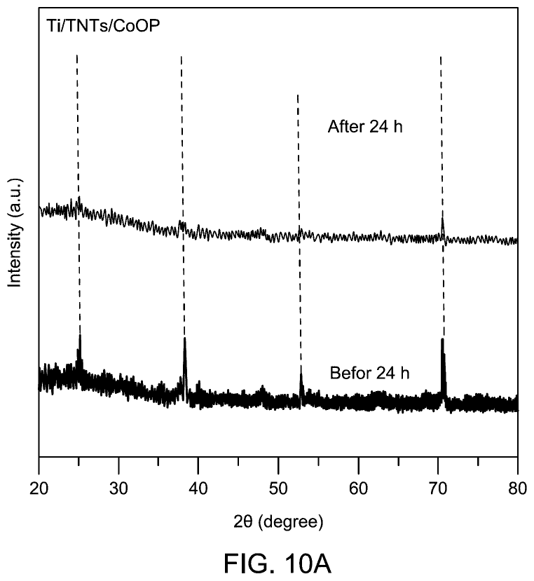

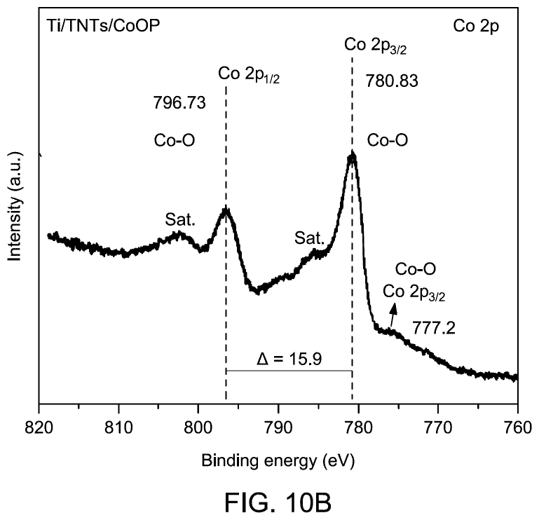

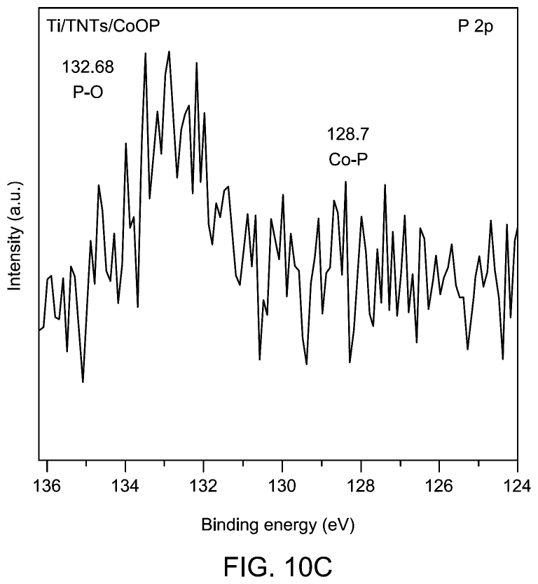

FIG. 9A-9B shows the high magnification and low magnification SEM images of Ti/TNTs/CoOP electrocatalysts after the long-term stability test (24 h) in 1.0 M KOH at a current density of 10 mAcm⁻². FIG. 9C shows the EDX spectrum of Ti/TNTs/COOP electrocatalyst after the long-term stability test (24 h) in 1.0 M KOH at a current density of 10 mA/cm². FIG. 10A shows the XRD of Ti/TNTs/CoOP and FIG. 10B-10C shows the XPS spectra of Co 2p and P 2p core levels in Ti/TNTs/COOP electrodes. All were measured after the long-term stability test (24 h). A comparison of the electrocatalytic HER activity of Ti/TNTs/CoOP in an alkaline medium with CoOP and CoP deposited on planer substrates is tabularized in Table 1. A comparison of the the electrocatalytic HER activity of Ti/TNTs/CoOP in an alkaline medium with CoOP and CoP deposited on 3D structure substrates is tabularized in Table 2.

TABLE 1
Comparing the electrocatalytic HER activity of Ti/TNTs/CoOP in an
alkaline medium with CoOP and CoP deposited on planer substrates.

| | Electrode | η (mV) @ | | |
|---|---|---|---|---|
| Electrocatalyst | supports | 10 mA/cm² | Electrolyte | Ref. |
| CoOP nanosphere Electrodeposited on | Ti foil | 130 | KOH | Present |
| Titanium nanotubes | | | | Application |
| Co₂P/CoP hollow nanospheres embedded | Glassy | 118 | KOH | [1] |
| in N-doped carbon nanotubes | Carbon | | | |
| Amorphous CoP synthesis by hot | FTO | 228 | KOH | [2] |
| injection method- supported on FTO by | | | | |
| electrophoretic deposition (EPD) | | | | |
| CoP/N-doped carbon (CoP—NC) | Glassy | 167 | KOH | [3] |
| synthesis by phosphatization method | carbon | | | |
| CoP/Co2P heterostructure electrode was | Glassy | 133 | KOH | [4] |
| fabricated via a template-free Strategy | carbon | | | |
| and phosphorization method | | | | |
| Cobalt phosphide nanoparticles nitrogen- | Glassy | 94 | KOH | [5] |
| doped carbon nanotube as (CP@NCNT) | carbon | | | |
| synthesized by spray drying and thermal | | | | |
| treatments | | | | |
| CoP nanosheets activated by in-situ | Glassy | 100 | KOH | [6] |
| electrochemical method to design | carbon | | | |
| Co(OH)x@CoP | | | | |
| CoP@NCNTs-supported nitrogen-doped | Glassy | 234 | KOH | [7] |
| carbon nanotubes synthesis by | carbon | | | |
| hydrothermal method | | | | |
| O₂ incorporated Co₂P synthesis by | Rotating | 160 | KOH | [8] |
| phosphorization method | disk | | | |
| | glassy | | | |
| | carbon | | | |
| | electrode | | | |
| CoP-NrGO-synthesized by | Glassy | 184 | KOH | [9] |
| phosphidation method | carbon | | | |

Ref. [1]: Z. Lu, et. al., Chemical Engineering Journal, 430 (2022) 132877, incorporated herein by reference in its entirety.
Ref. [2]: R. Beltrán-Suito, et. al., Journal of Materials Chemistry A, 7 (2019) 15749-15756, incorporated herein by reference in its entirety.
Ref. [3]: Y. Lai, et. al., Electrochimica Acta, 375 (2021) 137966, incorporated herein by reference in its entirety.
Ref. [4]: G. Liu, et. al., Journal of Power Sources, 486 (2021) 229351, incorporated herein by reference in its entirety.
Ref. [5]: D. Yang, et. al., Journal of Energy Chemistry, 52 (2021) 130-138, incorporated herein by reference in its entirety.
Ref. [6]: L. Su, et. al., Chemical Science, 10 (2019) , incorporated herein by reference in its entirety.
Ref. [7]: H. Zhao, et. al., Journal of Alloys and Compounds, 927 (2022) 167057, incorporated herein by reference in its entirety.
Ref. [8]: K. Xu, et. al., Advanced Materials, 29 (2017) 1606980, incorporated herein by reference in its entirety.
Ref. [9]: T. Veettil Vineesh, et. al., ChemElectroChem, 7 (2020) 3319-3323, incorporated herein by reference in its entirety.

TABLE 2
Comparing the electrocatalytic HER activity of Ti/TNTs/CoOP in an alkaline
medium with CoOP and CoP deposited on 3D structure substrates.

| | | η (mV) @ | | |
|---|---|---|---|---|
| Electrocatalyst | 3D substrates | 10 mA/cm² | Electrolyte | Ref. |
| Cobalt phosphide oxide composite | Carbon cloth | 43 | KOH | [10] |
| catalyst supported carbon cloth | | | | |
| (CoP—CoxOy/CC) by phosphidation method | | | | |
| 3D hierarchical CoP@N-doped carbon | Carbon foam or | 151 | KOH | [11] |
| composite foam as (CoP@NC/CF) | Nickel foam | | | |
| synthesized via phosphorization | | | | |
| method | | | | |
| Co₂P/CoP@NF hybrid synthesis by | Nickel foam | 61 | KOH | [12] |
| phosphidation method | | | | |
| CoP/Co2P/NCNT@CF synthesis by | Carbon foam | 133 | KOH | [13] |
| phosphorization method | | | | |
| 3D microstructure CoP synthesis by | Nickel foam | 117 | KOH | [14] |
| phosphorization method | | | | |
| Cobalt phosphides confined in porous | Carbon paper | 76 | KOH | [15] |
| P-doped carbon materials (Co—P@PC) | | | | |
| by calcinating process. | | | | |
| Cobalt phosphides electrodeposited on | Porous carbon | 140 | KOH | [16] |
| carbon porous membrane by in situ | membrane | | | |
| electrodeposition method | | | | |
| Cobalt phosphorus arrays modified | Copper foam | 148 | KOH | [17] |
| saccharin as (Co—P(SA)/CF) prepared | | | | |
| via electrodeposition method | | | | |

Ref. [10]: M. M. Alsabban, et. al., ACS nano, 16 (2022) 3906-3916, incorporated herein by reference in its entirety.
Ref. [11]: Y. Wang, et. al., Applied Surface Science, 505 (2020) 144503, incorporated herein by reference in its entirety.
Ref. [12]: G. Huang, et. al., Journal of Catalysis, 390 (2020) 23-29, incorporated herein by reference in its entirety.
Ref. [13]: L. Zhang, et. al., ACS omega, 7 (2022) 12846-12855, incorporated herein by reference in its entirety.
Ref. [14]: K. Ge, et. al., International Journal of Hydrogen Energy, 44 (2019) 13490-13501, incorporated herein by reference in its entirety.
Ref. [15]: J. Wu, et. al., Small, 16 (2020) 1900550, incorporated herein by reference in its entirety.
Ref. [16]: X. Li, et. al., Journal of Alloys and Compounds, 829 (2020) 154535, incorporated herein by reference in its entirety.
Ref. [17]: R. Deng, et. al., Applied Surface Science, (2023) 156456, incorporated herein by reference in its entirety.

Numerous modifications and variations of the present disclosure are possible in light of the above teachings. Therefore, it is to be understood that within the scope of the appended claims, the invention may be practiced other than as specifically described herein.

1. An electrocatalyst, including:
a titanium-including substrate;
an array of titanium dioxide nanotubes disposed on the Ti-including substrate; and
cobalt oxyphosphide (CoOP) nanostructures disposed on a surface of the titanium dioxide nanotubes, wherein
the titanium dioxide nanotubes are crystalline by powder X-ray diffraction (PXRD) and the CoOP is amorphous by PXRD; and
the CoOP nanostructures are substantially spherical and have a mean size of 75 to 400 nanometers.

2. The electrocatalyst of claim 1, wherein the titanium-including substrate is titanium metal.

3. The electrocatalyst of claim 1, wherein the titanium dioxide nanotubes are disposed substantially perpendicular to the titanium-including substrate.

4. The electrocatalyst of claim 1, wherein the CoOP nanostructures are disposed on a surface of the titanium dioxide nanotubes which is at least one selected from an inner surface of the titanium dioxide nanotubes and a surface opposite the titanium-including substrate.

5. The electrocatalyst of claim 4, wherein the CoOP nanostructures are disposed on both an inner surface of the titanium dioxide nanotubes and a surface opposite the titanium-including substrate.

6. The electrocatalyst of claim 1, wherein the titanium dioxide nanotubes have a mean diameter of 75 to 400 nm, have a mean length of 5 to 50 micrometers.

7. The electrocatalyst of claim 1, wherein the titanium dioxide nanotubes have the anatase structure.

8. The electrocatalyst of claim 1, wherein the electrocatalyst has a hydrogen evolution reaction potential required to generate a current density of 10 mA/cm² in 1.0 M potassium hydroxide of 100 to 160 mV relative to the reversible hydrogen electrode.

9. The electrocatalyst of claim 1, wherein the electrocatalyst has a Tafel plot for overpotential vs logarithm of current density that is linear with a slope of 65 to 80 mV/dec.

10. The electrocatalyst of claim 1, wherein the electrocatalyst has a charge transfer resistance of 0.1 to 7.5 Ω/cm².

11. A method of forming the electrocatalyst of claim 1, the method including
electrochemically anodizing the titanium-including substrate in a solution including ammonium fluoride and ethylene glycol to form an anodized substrate;
calcining the anodized substrate to form a bare array; and
electrochemically depositing CoOP by applying a potential of −2.5 to −0.25 V vs Ag/AgCl to the bare array in an aqueous solution including a cobalt ion source and a hypophosphite source to form the electrocatalyst.

12. The method of claim 11, wherein ammonium fluoride is present in the solution in an amount of 0.1 to 0.50 wt. %.

13. The method of claim 11, further including
pre-anodizing the titanium-including substrate in a solution including ammonium fluoride and ethylene glycol to form a pre-anodized substrate; and
ultrasonically treating the pre-anodized substrate.

14. The method of claim 11, wherein the electrochemically anodizing is performed at 50 to 75 V.

15. The method of claim 11, wherein the calcining is performed at 350 to 550° C. for 1 to 4 hours.

16. The method of claim 11, wherein the cobalt ion source is cobalt chloride, and the hypophosphite source is sodium hypophosphite.

17. The method of claim 11, wherein the aqueous solution including a cobalt ion source and a hypophosphite source further includes potassium chloride and citric acid.

18. The method of claim 11, wherein the electrochemically depositing is performed with a total quantity of electrical charge of 0.5 to 7.5 C/cm².

19. A method of producing hydrogen gas by a hydrogen evolution reaction, the method including:
contacting the electrocatalyst of claim 1 with an aqueous electrolyte solution having a pH of 10 to 14; and
applying a potential of 1 to 350 mV to the electrocatalyst and a counter electrode immersed in the aqueous electrolyte solution.

20. The method of claim 19, wherein the aqueous electrolyte solution includes 0.25 to 2.5 M KOH.
